(19) United States
(12) Patent Application Publication
(10) Pub. No.: US 2017/0279212 A1
(43) Pub. Date: Sep. 28, 2017

(54) ELASTIC CONTACT ELEMENT AND ELECTRICAL CONNECTOR USING SAID CONTACT ELEMENT

(71) Applicant: AVIC JONHON OPTRONIC TECHNOLOGY CO., LTD, Luoyang, Henan (CN)

(72) Inventors: Guoqi ZHOU, Luoyang, Henan (CN); Lei ZHANG, Luoyang, Henan (CN); Xiaoguang ZHANG, Luoyang, Henan (CN)

(73) Assignee: AVIC JONHON OPTRONIC TECHNOLOGY CO., LTD, Luoyang, Henan (CN)

(21) Appl. No.: 15/506,934

(22) PCT Filed: Oct. 29, 2015
(86) PCT No.: PCT/CN2015/093251

§ 371 Date: Feb. 27, 2017

(30) Foreign Application Priority Data
Aug. 29, 2014 (CN) 201410434276.0

(51) Int. Cl. H01R 13/24; H01R 4/70

(52) U.S. Cl. CPC H01R 13/2407; H01R 13/2492; H01R 4/70

(57) ABSTRACT

Disclosed are an elastic contact element and an electrical connector using the contact element. The elastic contact element comprises two contact parts in conductive contact with corresponding connectors and a connecting part located between the two contact parts, each of the two contact parts is provided with an arc part, an outside surface of the arc part constitutes a jacking surface in conductive contact with the corresponding connector, the openings of the two arc parts are arranged oppositely, and one end of one arc part is connected with one end of the other arc part by the connecting part, the connecting part is provided with a convex part bent inwards. When the elastic contact element is pressed in use, the arc parts of the contact parts and the convex part bent inwards all form deformed parts to disperse the deformation stress, thereby prolonging the service life of the elastic contact element. The elastic contact element, which is only formed by simple arcs, does not have a special requirement for materials.

### FIELD OF THE INVENTION

The present invention relates to the field of electrical connectors, and particularly, relates to an elastic contact element and an electrical connector using said contact element.

### BACKGROUND

Adapters are common ones among electrical connectors, and can be divided into plug-in adapters and terminating adapters according to different contact modes. The terminating adapter realizes electrical connection via a jacking contact between the corresponding ends of a contact element and an adapter connector.

The contact elements for the terminating adapters are mostly elastic contact elements, and at present, the common elastic contact elements for the terminating adapters are mainly in the following three shapes: 1, C shape, shown in FIG. 1; 2, spatial V shape, shown in Fig. 2; and 3, helical spring shape, shown in FIG. 3.

Among the above three kinds of elastic contact elements, when the C-shaped and spatial V-shaped elastic contact elements are stressed during working, the bending points are single, so plastic deformation due to fatigue is easily produced and service lives are short; the requirement for materials for the helical spring-shaped elastic contact elements is relatively high, and the common copper material cannot provide enough elastic contact force, so special materials are needed and the manufacturing cost is relatively high; besides, relatively high loop inductance of helical springs is also unbeneficial to optimizing the performance of the adapters.

### SUMMARY

The aim of the present invention is to provide an elastic contact element, with low material requirement and long service life, which is used for a terminating adapter.

Meanwhile, the aim of the present invention is also to provide an electrical connector using said elastic contact element.

In order to solve the above problems, the elastic contact element of the present invention adopts the following technical solution: the elastic contact element includes two contact parts in conductive contact with corresponding connectors and a connecting part located between the two contact parts, each of the two contact parts is provided with an arc part, an outside surface of the respective arc part constitutes a jacking surface in conductive contact with the corresponding connector, the two arc parts are arranged in a mouth-to-mouth mode and one end of one arc part is in transition connection with one end of the other arc part by the connecting part, and the connecting part is provided with a convex part bulged by inward bending.

The two contact parts are respectively U-shaped.

The contact parts and the connecting part are made of plates or bands.

The transition parts between the connecting part and the contact parts are arc-shaped.

The contact parts are U-shaped, one end of one contact part is connected with one end of the other contact part by the connecting part, and the other ends of the contact parts are overlapped.

The electrical connector adopts the following technical solution: the electrical connector includes an insulating plate, the insulating plate is provided with penetrating mounting holes, elastic contact elements are fixedly assembled in the mounting holes, the elastic contact element includes two contact parts in conductive contact with corresponding connectors and a connecting part located between the two contact parts, each of the two contact parts is provided with an arc part, an outside surface of the respective arc part constitutes a jacking surface in conductive contact with the corresponding connector, the two arc parts are arranged in a mouth-to-mouth mode and one end of one arc part is in transition connection with one end of the other arc part by the connecting part, and the connecting part is provided with a convex part bulged by inward bending.

The two contact parts are respectively U-shaped.

The contact parts and the connecting part are made of plates or bands.

The transition parts between the connecting part and the contact parts are arc-shaped.

The contact parts are U-shaped, one end of one contact part is connected with one end of the other contact part by the connecting part, and the other ends of the contact parts are overlapped.

The two contact parts of the elastic contact element respectively have an arc part, and their respective jacking surface in conductive contact with the corresponding connector is constituted by the outside surface of the arc part, the connecting part is provided with a convex part bulged by inward bending. Thus, when the elastic contact element is pressed in use, the arc parts of the contact parts and the convex part bulged by inward bending all form deformed parts to disperse the deformation stress, thereby prolonging the service life of the elastic contact element, and the elastic contact element, which is only formed by simple arcs and the like, does not have a special requirement for materials.

### BRIEF DESCRIPTION OF THE DRAWINGS

FIG. 1 is a structural schematic diagram of a C-shaped elastic contact element;

FIG. 2 is a structural schematic diagram of a spatial V-shaped elastic contact element;

FIG. 3 is a structural schematic diagram of a helical spring-shaped elastic contact element;

FIG. 4 is a structural schematic diagram of an embodiment of an elastic contact element;

FIG. 5 is a structural schematic diagram of an embodiment of an electrical connector;

FIG. 6 is a matching schematic diagram of an insulator of the electrical connector and elastic contact elements.

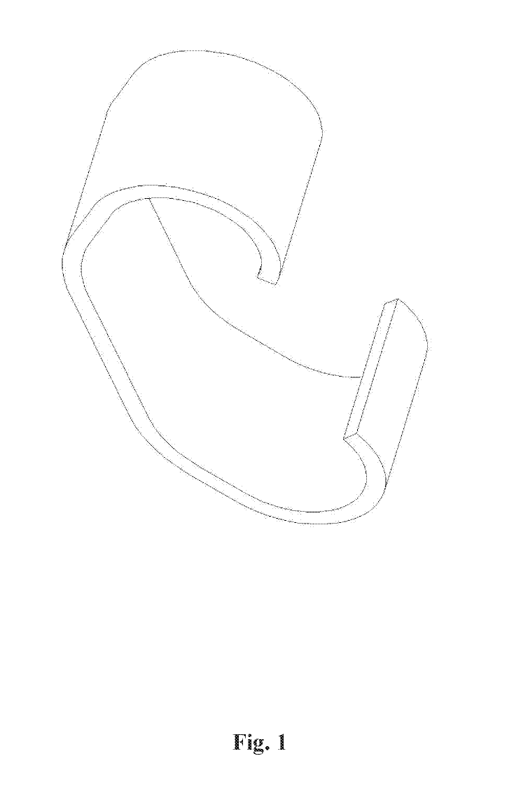

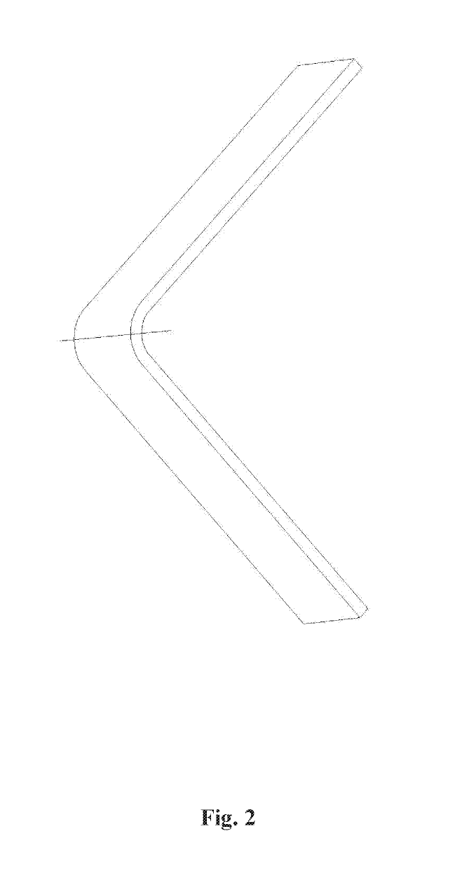

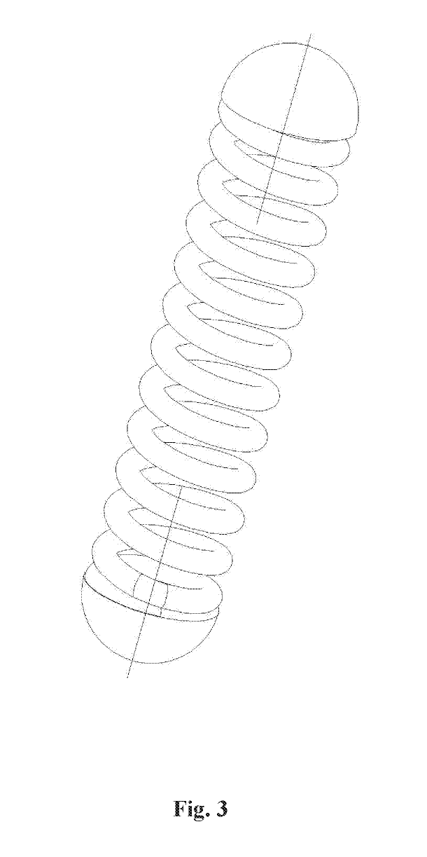

### DETAILED DESCRIPTION OF THE EMBODIMENTS

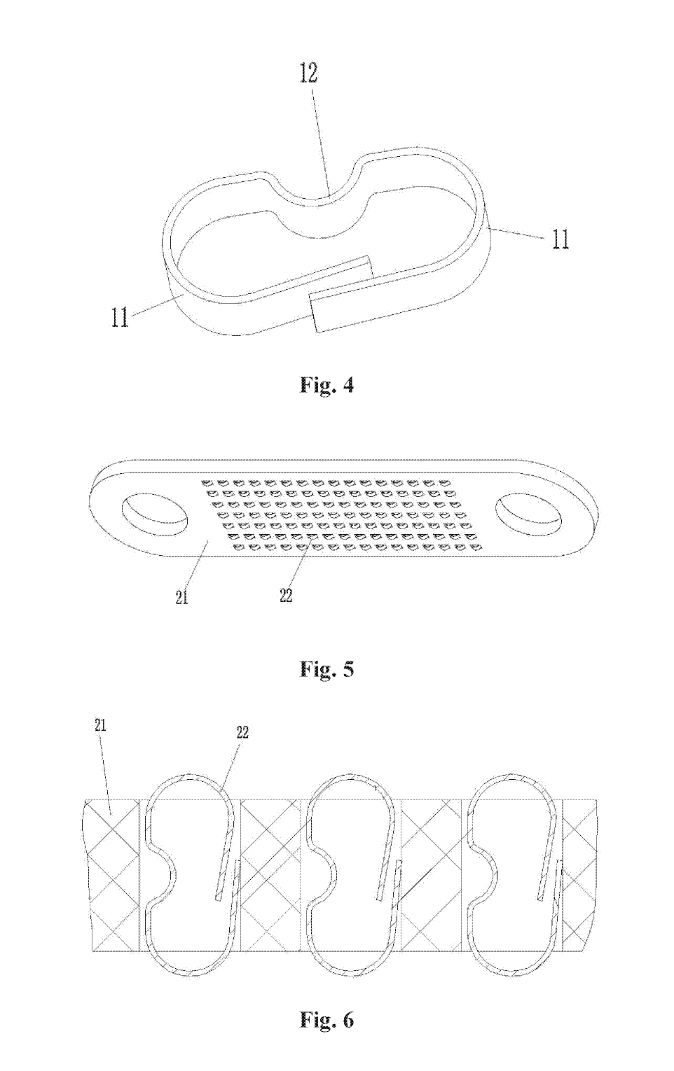

An embodiment of an elastic contact element is shown in FIG. 4, and the elastic contact element includes two contact parts 11 in conductive contact with corresponding connectors and a connecting part 12 located between the two contact parts.

The two contact parts 11 are respectively provided with an arc part, and an outside surface of the arc part constitutes a jacking surface in conductive contact with the corresponding connector. In this embodiment, the contact parts 11 are specifically U-shaped, the two contact parts are arranged in a mouth-to-mouth mode, the jacking surface is located on the outer side of the bottom of the U shape of the contact part, and the contact parts 11 are in transition connection via the connecting part 12. In this embodiment, the connecting part is connected with one adjacent end of each of the two contact parts, the connection positions of the contact parts and the connecting part are arc-shaped to avoid stress concentration, in addition, the connecting part is provided with an arc-shaped convex part, the convex part is formed by bending and bulged inwards. One end of one contact part is connected with one end of the other contact part via the connecting part, and the other ends of the contact parts are overlapped, so that the elastic contact element constitutes a similar “O”-shaped structure. In this embodiment, the contact parts and the connecting part are made of plates or bands.

In other embodiments of the elastic contact element, the contact parts and the connecting part can also be made of rods; the contact parts can also be C-shaped.

An embodiment of an electrical connector is shown in FIGS. 5-6, the electrical connector includes an insulating plate 21 and elastic contact elements 22, the insulating plate 21 is provided with mounting holes, the elastic contact elements 22 are fixedly assembled in the corresponding mounting holes, and in this embodiment, the structure of the elastic contact elements 22 is the same as that of the embodiment of the above-mentioned elastic contact element and is thus not redundantly described herein.

In other embodiments of the electrical connector, contact elements can also be in the form of hybrid assembly of the embodiment of the above-mentioned elastic contact element and other contact elements.

1. An elastic contact element, comprising two contact parts in conductive contact with corresponding connectors and a connecting part located between the two contact parts, wherein each of the two contact parts is provided with an arc part, an outside surface of the respective arc part constitutes a jacking surface in conductive contact with the corresponding connector, the two arc parts are arranged in a mouth-to-mouth mode and one end of one arc part is in transition connection with one end of the other arc part by the connecting part, and the connecting part is provided with a convex part bulged by inward bending.

2. The elastic contact element as set forth in claim 1, wherein the two contact parts are respectively U-shaped.

3. The elastic contact element as sat forth in claim 1, wherein the contact parts and the connecting part are made of plates or bands.

4. The elastic contact element, as set forth in claim 1, wherein the transition parts between the connection part and the contact parts are arc-shaped.

5. The elastic contact element as set forth in claims 1, wherein the contact parts are U-shaped, one end of one contact part is connected with one end of the other contact part by the connecting part, and the other ends of the contact parts are overlapped.

6. An electrical connector, comprising an insulating plate, the insulating plate is provided with penetrating mounting holes, elastic contact elements are fixedly assembled in the mounting holes, the elastic element comprising two contact parts in conductive contact with corresponding connectors and a connecting part located between the two contact parts, wherein each of the two contact parts is provided with an arc part, an outside surface of the respective arc part constitutes a jacking surface in conductive contact with the corresponding connector, the two arc parts are arranged in a mouth-to-mouth mode and one end of one arc part is in transition connection with one end of the other arc part by the connecting part, and the connecting part is provided with a convex part bulged by inward bending.

7. The electrical connector as set forth in claim 6, wherein the two contact parts are respectively U-shaped.

8. The electrical connector as set forth in claim 6, wherein the contact parts and the connecting part are made of plates or bands.

9. The electrical connector as set forth in claim 6, wherein the transition parts between the connecting part and the contact parts are arc-shaped.

10. The electrical connector as set forth in claims 6, wherein the contact parts are U-shaped, one end of one contact part is connected with one end of the other contact part by the connecting part, and the other ends of the contact parts are overlapped.

11. The elastic contact element as set forth in claim 3, wherein the contact parts are U-shaped, one end of one contact part is connected with one end of the other contact part by the connecting part, and the other ends of the contact parts are overlapped.

12. The elastic contact element as set forth in claim 4, wherein the contact parts are U-shaped, one end of one contact part is connected with one end of the other contact part by the connecting part, and the other ends of the contact parts are overlapped.

13. The electrical connector as set forth in claim 8, wherein the contact parts are U-shaped, one end of one contact part is connected with one end of the other contact part by the connecting part, and the other ends of the contact parts are overlapped.

14. The electrical connector as set forth in claim 9, wherein the contact parts are U-shaped, one end of one contact part is connected with one end of the other contact part by the connecting part, and the other ends of the contact parts are overlapped.
